(19) United States
(12) Patent Application Publication
(10) Pub. No.: US 2026/0338962 A1
(43) Pub. Date: Oct. 29, 2026

(54) Method for Tightly Coupled Deep Learning and GNSS Integration for Positioning in Urban Canyons

(71) Applicant: THE HONG KONG POLYTECHNIC UNIVERSITY, Hong Kong (CN)

(72) Inventors: Weisong WEN, Hong Kong (CN); Runzhi HU, Hong Kong (CN); Penghui XU, Hong Kong (CN); Yihan ZHONG, Hong Kong (CN)

(21) Appl. No.: 19/654,626

(22) Filed: Apr. 22, 2026

Related U.S. Application Data
(60) Provisional application No. 63/794,663, filed on Apr. 25, 2025.

(51) Int. Cl. G01S 19/23; G01S 19/39; G06N 3/048; G06N 3/084

(52) U.S. Cl. CPC G01S 19/23; G01S 19/396; G06N 3/048; G06N 3/084

(57) ABSTRACT

In urban canyons, the performance of a global navigation satellite system (GNSS) could be significantly degraded due to blockage of direct GNSS signals. Pseudorange measurements are largely affected and a conventional model of weighting observations is unsuitable. By integrating deep learning into a GNSS positioning process to enhance positioning accuracy in the urban canyons, this work provides an innovative indirect training approach using deep learning to optimize both pseudorange bias and weight estimation, aiming to minimize the positioning errors. To support this integration, pyrtklib is developed, which is a Python-compatible interface for RTKLIB (a GNSS library), bridging the gap between traditional GNSS algorithms, typically developed in Fortran or C, and modern Python-based artificial-intelligence frameworks. Comparative analyses demonstrate that pyrtklib surpasses established tools like goGPS and RTKLIB in positioning accuracy, marking a significant advancement in the field.

### CROSS-REFERENCE TO RELATED APPLICATIONS

This application claims the benefit of U.S. Provisional Patent Application Ser. No. 63/794,663 filed Apr. 25, 2025, the disclosure of which is incorporated by reference herein in its entirety.

### ABBREVIATIONS

2D two-dimensional
3D three-dimensional
AI artificial intelligence
CDF cumulative distribution function
C/N₀ carrier-to-noise density
ECEF Earth-centered, Earth-fixed
GNSS global navigation satellite system
ITS intelligent transportation system
LOS line-of-sight
MSE mean square error
NLOS non-line-of-sight
OLS ordinary least squares
ReLU rectified linear unit
RTK real-time kinematic
TDL-B pseudorange bias correction
TDL-BW bias correction and weights prediction
TDL-W weights prediction
WLS weighted least squares

### TECHNICAL FIELD

This application relates to locating a receiver on Earth by using a GNSS integrated with deep learning.

### BACKGROUND

With the rapid growth of computing speed and power, AI, epitomized by deep learning, is now practical for everyday use. Due to its excellent non-linear fitting capability, deep learning has proven effective in numerous fields, including computer vision and natural language process. In modern ITS's, deep learning also demonstrates potential in areas such as traffic control, autonomous driving, and human behavior analysis. Global positioning, commonly known as GNSS positioning, is crucial for perception and decision-making within ITS. Consequently, there is a pressing need within the ITS community to integrate deep learning techniques into global positioning strategies.

Currently, GNSS positioning accuracy can achieve centimeter-level precision under open skies. However, in urban canyons, the performance dramatically declines as GNSS signals are diffracted, reflected, and even obstructed by high-rise buildings. To mitigate the adverse effects of NLOS and multipath interference, two strategies are implemented: directly correcting measurements to improve accuracy; and downweighing measurements from low-quality signals in the WLS solution process. Traditional methods use physical models and empirical formulas to model biases and weights, providing high interpretability but often struggling in complex and dynamically changing environments. In contrast, data-driven deep learning approaches can potentially model biases and weights more effectively, provided that the training data is of high quality.

Previous approaches in deep learning-aided GNSS have primarily focused on correcting pseudorange bias, with few researchers exploring weight estimation. Unlike pseudorange bias, the ground truth for weight cannot be directly derived from ground truth positions. From a deep learning perspective, one solution is to treat both bias and weight as parameters and to propagate errors back from the positioning outcomes. However, this approach requires a deep integration of deep learning with GNSS, highlighting a significant gap between these two technologies.

Deep learning frameworks and applications have overwhelmingly adopted Python due to its simplicity, flexibility, and the vast ecosystem of libraries and tools available, such as TensorFlow and PyTorch. This accessibility and ease of use facilitate rapid prototyping and deployment of complex models, making Python the language of choice for most new developments in deep learning and AI. Meanwhile, GNSS software historically leans on programming languages like Fortran and C. Though these languages offer high performance and control over hardware interaction, which are critical for the real-time processing demands and precision required in satellite navigation, these languages are not equipped with good compatibility with Python. This divergence in technological stacks presents a significant challenge for integrating cutting-edge AI methodologies, like deep learning, directly into traditional GNSS software systems. Bridging this gap requires either extending these systems to interface with Python-based tools or developing new capabilities within the GNSS software to support advanced machine learning techniques directly in C or Fortran, both of which entail substantial development and potential refactoring of existing codebases.

There is a need in the art for bridging the above-mentioned gap.

### SUMMARY

Mathematical equations referenced in this Summary can be found in Detailed Description.

A first aspect of the present disclosure is to provide a first method for determining a location of a receiver on Earth in a GNSS.

The first method comprises: receiving, by the receiver, a plurality of satellite signals from a plurality of satellites of the GNSS, wherein an individual satellite in the plurality of satellites is arranged to transmit a corresponding satellite signal in the plurality of satellite signals to the receiver; estimating, by a processor, a plurality of first pseudoranges for the plurality of satellites according to the plurality of satellite signals, the individual satellite being associated with a corresponding first pseudorange in the plurality of pseudoranges, the corresponding first pseudorange being measured from the individual satellite to the receiver; setting up, by the processor, a reusable subprocess for determining the location of the receiver through estimating a plurality of pseudoranges and a plurality of weights for the plurality of satellites, the individual satellite being associated with a corresponding pseudorange in the plurality of pseudoranges and a corresponding weight in the plurality of weights, the corresponding pseudorange being obtained from the corresponding first pseudorange after correction is made, the corresponding weight being inversely varying with respect to an error in measuring the corresponding pseudorange; predicting, by the processor, the location of the receiver by a predicting process, wherein the predicting process is the reusable process; and before the location of the receiver is predicted, training, by the processor, the network with a training process according to a training dataset containing ground-truth positions, wherein the training process includes the reusable subprocess.

In the first method, the reusable subprocess comprises the steps of: (a) determining an OLS solution of the location of the receiver according to the plurality of first pseudoranges; (b) determining a plurality of residuals for the plurality of satellites from the OLS solution of the location of the receiver; (c) extracting the corresponding first pseudorange from the plurality of first pseudoranges, and a corresponding residual associated with the individual satellite from the plurality of residuals; (d) determining a C/N₀ of the corresponding satellite signal received at the receiver, and an elevation angle of the corresponding satellite with respect to the receiver; (e) using a bias correction and weights prediction network to simultaneously determine a corresponding pseudorange bias and the corresponding weight according to the C/N₀ of the corresponding satellite signal, the elevation angle of the corresponding satellite, and the corresponding residual associated with the individual satellite, wherein the corresponding pseudorange bias is associated with the individual satellite; (f) subtracting the corresponding pseudorange bias from the corresponding first pseudorange to yield a corrected pseudorange, wherein the corrected pseudorange is set to be the corresponding pseudorange; (i) repeating the steps (c)-(f) for respective satellites in the plurality of satellites until the plurality of pseudoranges and the plurality of weights are determined; and (j) performing a WLS positioning process to determine the location of the receiver according to the plurality of pseudoranges and the plurality of weights.

In certain embodiments, the network comprises: an input layer for receiving the C/N₀ of the corresponding satellite signal, the elevation angle of the corresponding satellite, and the corresponding residual associated with the individual satellite; an output layer for outputting the corresponding pseudorange bias and the corresponding weight; and a plurality of hidden layers between the input and output layers. In addition, a ReLU is used as a first activation function throughout the input layer and the plurality of hidden layers, and a sigmoid function is used as a second activation function in generating the corresponding weight in the output layer.

In certain embodiments, the network is further configured as follows. The input layer is configured to receive a feature vector comprising the C/N₀, the elevation angle, and the corresponding residual. The plurality of hidden layers comprises at least two hidden layers arranged in series, wherein a number of processing nodes in each successive hidden layer is greater than a number of processing nodes in a preceding hidden layer. The output layer is configured to output the corresponding pseudorange bias and the corresponding weight.

In certain embodiments, the plurality of hidden layers consists of first and second hidden layers connected in series. The first hidden layer connects to the input layer. The second hidden layer connects to the output layer.

In certain embodiments, the network has the following configuration. The input layer has a size of 3×1. The first hidden layer has a size of 64×1. The second hidden layer has a size of 128×1. The output layer has a size of 2×1.

In certain embodiments, the training process is arranged to learn a set of parameters, Θ, within the network by determining Θ according to Equation (29).

In certain embodiments, the training process further includes: calculating the loss function; calculating an adjustment to Θ according to the loss function; and backpropagating the adjustment to the network for optimizing the network.

A second aspect of the present disclosure is to provide a second method for determining a location of a receiver on Earth in a GNSS.

The second method comprises: receiving, by the receiver, a plurality of satellite signals from a plurality of satellites of the GNSS, wherein an individual satellite in the plurality of satellites is arranged to transmit a corresponding satellite signal in the plurality of satellite signals to the receiver; estimating, by a processor, a plurality of first pseudoranges for the plurality of satellites according to the plurality of satellite signals, the individual satellite being associated with a corresponding first pseudorange in the plurality of pseudoranges, the corresponding first pseudorange being measured from the individual satellite to the receiver; estimating, by the processor, a plurality of weights for the plurality of satellites, the plurality of weights being used in a WLS positioning process for determining the location of the receiver; setting up, by the processor, a reusable subprocess for determining the location of the receiver through estimating a plurality of pseudoranges for the plurality of satellites, the individual satellite being associated with a corresponding pseudorange in the plurality of pseudoranges and a corresponding weight in the plurality of weights, the corresponding pseudorange being obtained from the corresponding first pseudorange after correction is made, the corresponding weight being inversely varying with respect to an error in measuring the corresponding pseudorange; predicting, by the processor, the location of the receiver by a predicting process, wherein the predicting process is the reusable process; and before the location of the receiver is predicted, training, by the processor, the network with a training process according to a training dataset containing ground-truth positions, wherein the training process includes the reusable subprocess.

In the second method, the reusable subprocess comprises the steps of: (a) determining an OLS solution of the location of the receiver according to the plurality of first pseudoranges; (b) determining a plurality of residuals for the plurality of satellites from the OLS solution of the location of the receiver; (c) extracting the corresponding first pseudorange from the plurality of first pseudoranges, and a corresponding residual associated with the individual satellite from the plurality of residuals; (d) determining a C/N₀ of the corresponding satellite signal received at the receiver, and an elevation angle of the corresponding satellite with respect to the receiver; (e) using a pseudorange bias correction network to determine a corresponding pseudorange bias according to the C/N₀ of the corresponding satellite signal, the elevation angle of the corresponding satellite, and the corresponding residual associated with the individual satellite, wherein the corresponding pseudorange bias is associated with the individual satellite; (f) subtracting the corresponding pseudorange bias from the corresponding first pseudorange to yield a corrected pseudorange, wherein the corrected pseudorange is set to be the corresponding pseudorange; (i) repeating the steps (c)-(f) for respective satellites in the plurality of satellites until the plurality of pseudoranges is determined; and (j) performing the WLS positioning process to determine the location of the receiver according to the plurality of pseudoranges and the plurality of weights.

In certain embodiments, the network comprises: an input layer for receiving the C/N₀ of the corresponding satellite signal, the elevation angle of the corresponding satellite, and the corresponding residual associated with the individual satellite; an output layer for outputting the corresponding pseudorange bias; and a plurality of hidden layers between the input and output layers. In addition, a ReLU is used as an activation function throughout the input layer and the plurality of hidden layers.

In certain embodiments, the network is further configured as follows. The input layer is configured to receive a feature vector comprising the C/N₀, the elevation angle, and the corresponding residual. The plurality of hidden layers comprises at least two hidden layers arranged in series, wherein a number of processing nodes in each successive hidden layer is greater than a number of processing nodes in a preceding hidden layer. The output layer is configured to output the corresponding pseudorange bias.

In certain embodiments, the plurality of hidden layers consists of first and second hidden layers connected in series. The first hidden layer connects to the input layer. The second hidden layer connects to the output layer.

In certain embodiments, the network has the following configuration. The input layer has a size of 3×1. The first hidden layer has a size of 64×1. The second hidden layer has a size of 128×1. The output layer has a size of 1×1.

In certain embodiments, the training process is arranged to learn a set of parameters, Θ, within the network by determining Θ according to Equation (16).

In certain embodiments, the training process further includes: calculating the loss function; calculating an adjustment to Θ according to the loss function; and backpropagating the adjustment to the network for optimizing the network.

A third aspect of the present disclosure is to provide a third method for determining a location of a receiver on Earth in a GNSS.

The third method comprises: receiving, by the receiver, a plurality of satellite signals from a plurality of satellites of the GNSS, wherein an individual satellite in the plurality of satellites is arranged to transmit a corresponding satellite signal in the plurality of satellite signals to the receiver; estimating, by a processor, a plurality of pseudoranges for the plurality of satellites according to the plurality of satellite signals, the individual satellite being associated with a corresponding pseudorange in the plurality of pseudoranges, the corresponding pseudorange being measured from the individual satellite to the receiver; setting up, by the processor, a reusable subprocess for determining the location of the receiver through estimating a plurality of weights for the plurality of satellites, the individual satellite being associated with a corresponding weight in the plurality of weights, the corresponding weight being inversely varying with respect to an error in measuring the corresponding pseudorange; predicting, by the processor, the location of the receiver by a predicting process, wherein the predicting process is the reusable process; and before the location of the receiver is predicted, training, by the processor, the network with a training process according to a training dataset containing ground-truth positions, wherein the training process includes the reusable subprocess.

In the third method, the reusable subprocess comprises the steps of: (a) determining an OLS solution of the location of the receiver according to the plurality of pseudoranges; (b) determining a plurality of residuals for the plurality of satellites from the OLS solution of the location of the receiver; (c) extracting the corresponding pseudorange from the plurality of pseudoranges, and a corresponding residual associated with the individual satellite from the plurality of residuals; (d) determining a C/N₀ of the corresponding satellite signal received at the receiver, and an elevation angle of the corresponding satellite with respect to the receiver; (e) using a weights prediction network to determine the corresponding weight according to the C/N₀ of the corresponding satellite signal, the elevation angle of the corresponding satellite, and the corresponding residual associated with the individual satellite; (f) repeating the steps (c)-(e) for respective satellites in the plurality of satellites until the plurality of weights is determined; and (g) performing a WLS positioning process to determine the location of the receiver according to the plurality of pseudoranges and the plurality of weights.

In certain embodiments, the network comprises: an input layer for receiving the C/N₀ of the corresponding satellite signal, the elevation angle of the corresponding satellite, and the corresponding residual associated with the individual satellite; an output layer for outputting the corresponding weight; and a plurality of hidden layers between the input and output layers. In addition, a sigmoid function is used as an activation function throughout the input layer, the plurality of hidden layers and the output layer.

In certain embodiments, the network is further configured as follows. The input layer is configured to receive a feature vector comprising the C/N₀, the elevation angle, and the corresponding residual. The plurality of hidden layers comprises at least two hidden layers arranged in series, wherein a number of processing nodes in each successive hidden layer is greater than a number of processing nodes in a preceding hidden layer. The output layer is configured to output the corresponding weight.

In certain embodiments, the plurality of hidden layers consists of first and second hidden layers connected in series. The first hidden layer connects to the input layer. The second hidden layer connects to the output layer.

In certain embodiments, the network has the following configuration. The input layer has a size of 3×1. The first hidden layer has a size of 64×1. The second hidden layer has a size of 128×1. The output layer has a size of 1×1.

In certain embodiments, the training process is arranged to learn a set of parameters, Θ, within the network by determining Θ according to Equation (22).

In certain embodiments, the training process further includes: calculating the loss function; calculating an adjustment to Θ according to the loss function; and backpropagating the adjustment to the network for optimizing the network.

Other aspects of the present disclosure are disclosed as illustrated by the embodiments hereinafter.

### BRIEF DESCRIPTION OF THE DRAWINGS

FIG. 1A depicts a detailed structure of a bias network.

FIG. 1B depicts a detailed structure of a weight network.

FIG. 1C depicts a detailed structure of a bias-weight network.

FIG. 2A depicts a training process.

FIG. 2B depicts a prediction process.

FIG. 3 plots loss curves for illustrating the training process for the bias and weight network.

FIG. 4A plot CDF curves for 3D error of five methods under comparison on KLT1 Dataset.

FIG. 4B plot CDF curves for 3D error of the five methods under comparison on KLT2 Dataset.

FIG. 4C plot CDF curves for 3D error of the five methods under comparison on Whampoa Dataset.

FIG. 5A plots boxplot graphs for 3D error of the five methods under comparison on KLT1 Dataset.

FIG. 5B plots boxplot graphs for 3D error of the five methods under comparison on KLT2 Dataset.

FIG. 5C plots boxplot graphs for 3D error of the five methods under comparison on Whampoa Dataset.

FIG. 6 depicts a first flowchart showing exemplary steps of a method as disclosed herein for determining a location of a receiver on Earth in a GNSS.

FIG. 7 depicts a second flowchart showing exemplary steps of a reusable subprocess that is used in the disclosed method.

Skilled artisans will appreciate that elements in the figures are illustrated for simplicity and clarity and have not necessarily been depicted to scale.

### DETAILED DESCRIPTION

To fill the gap as mentioned in Background, we make the Python binding, named pyrtklib, for the most popular open-source GNSS library, RTKLIB. The pyrtklib provides access to the full functionalities of RTKLIB, combining the speed of C with the convenience of Python. Based on this, we introduce a tightly coupled deep learning approach for weight estimation and bias correction in single point positioning, which has been validated on our datasets.

As an overview of the present disclosure, the scope of this work contains five aspects and is illustrated as follows.

First, the present disclosure develops a network to predict pseudorange biases and integrates these predictions into the correction of GNSS pseudorange measurements, tightly coupling them within the least squares process.

Second, the present disclosure designs a network specifically to predict weights for each measurement, which are then utilized in the weighted least squares process.

Third, the present disclosure presents a network that simultaneously predicts both weights and biases for each measurement, applying these predictions in the weighted least squares process to improve accuracy.

Fourth, the present disclosure provides a Python package named pyrtklib, a Python binding for RTKLIB. Using meta-programming techniques, we automatically translate RTKLIB's header files into Python binding code via pycparser and pybind11, maintaining the integrity of RTKLIB's constants and functions.

Fifth, building on pyrtklib, the present disclosure proposes a subsystem that integrates deep learning into the GNSS positioning process. This innovative framework is engineered for training and predicting weights and biases within the least squares solving process.

Before detailing pyrtklib, we provide a review of related works.

### A. Related Works

### A.1. GNSS Tools

There are several existing GNSS tools as shown in Table 1. Bernese GNSS and MuSNAT are two popular commercial GNSS software, however, their closed-source nature limits their usability for algorithm development. NavSU, MAAST, and goGPS are open-source software programs written in Matlab. Despite their open-source status, a paid Matlab license is still required for their use. Laika and gnss_lib_py both are Python libraries, but they only provide basic GNSS functions and lack the support for RTK and precise point positioning. RTKLIB is a comprehensive open-source GNSS tool that enjoys widespread use not only within the GNSS community but also in the robotics sector. However, its C-based architecture poses integration challenges with Python. Additionally, while the above tools utilize empirical formulas to predict variance and control weights, they lack the capability to correct pseudorange biases. To address this need, we developed pyrtklib. This library, written in C++ and integrated into Python, combines the efficiency of C with the ease of use of Python.

### A.2. Deep Learning in GNSS

We categorize the application of deep learning in GNSS into the following groups: (a) improved pseudorange measurement; (b) measurement status prediction; (c) positioning level information; and (d) measurement error prediction.

The approach outlined in group (a) aims to enhance the correlator and discriminator at the receiver level to improve signal quality control. These methods are highly integrated, forming a super tightly coupled relationship between deep learning and GNSS. However, upgrading the receiver hardware is challenging to scale rapidly. The objective of group (b) is to utilize deep learning to classify NLOS and multipath signals in advance, thus eliminating or mitigating their adverse effects. The goal of group (c) is to predict the final positioning error and apply corrections. These strategies represent preprocess and postprocess applications that are loosely coupled with deep learning in GNSS. Lastly, the algorithms discussed in group (d) have a direct impact on the measurements and are considered tightly coupled.

Super tightly coupled methods require support from either hardware or software-based receivers. In contrast, the labels for loosely coupled methods are easily accessible when the ground truth position is known, allowing the training process to be decoupled from the positioning process. However, for tightly coupled methods, measurement correction is intricately linked to positioning, making it impractical to separate training and positioning processes. In such scenarios, it is advantageous for both positioning and training to be conducted in the same programming language. To this end, our framework built on pyrtklib is specifically designed to support tightly coupled deep learning and GNSS approaches. We anticipate that our framework will facilitate the development of tightly coupled algorithms.

TABLE 1
Comparison of existing GNSS tools.

| | | | Weight | Bias | |
|---|---|---|---|---|---|
| | | Open- | Predic- | Correc- | Weight + |
| Tool | Language | source | tion | tion | Bias |
| RTKLIB | C | Y | Y | N | N |
| Bernese GNSS | Fortran | N | Y | N | N |
| MuSNAT | Matlab/C++ | N | Y | N | N |
| NavSU | Matlab | Y | Y | N | N |
| MAAST | Matlab | Y | Y | N | N |
| goGPS | Matlab | Y | Y | N | N |
| Laika | Python | Y | Y | N | N |
| gnss_lib_py | Python | Y | Y | N | N |
| pyrtklib | Python | Y | Y | Y | Y |

### B. Tightly Coupled Deep Learning Framework for GNSS

### B.1. GNSS Position Principle

A standard GNSS model can be formulated as:

p=r+cΔt+l+T+∈ (1)

Here, p represents the pseudorange measured by the receiver, c is the speed of light, and I and T signify the ionospheric and tropospheric delays, respectively. These delays are typically estimated using atmospheric models in single point positioning. In Equation (1), Δt denotes the receiver's time bias and e represents Gaussian noise. The variable r denotes the distance between the satellite and the receiver, which is formulated as follows:

r={square root over ((x^{(s)}−xᵣ)²+(y^{(s)}−yᵣ)²+(z^{(s)}−zᵣ)²)} (2)

where x^{(s)}, y^{(s)}, z^{(s)} and xᵣ, yᵣ, zᵣ are the coordinates of the satellite and of the receiver in ECEF coordinate system, respectively. The superscript “(s)” represents the index of the satellite. When there are n pseudorange measurements, the observation function is:

$$\tilde{Z} = h ( y ) = [ \begin{matrix}{r}_{1} + c Δ t + {I}_{1} + {T}_{1} \\ {r}_{2} + c Δ t + {I}_{2} + {T}_{2} \\ … \\ {r}_{n} + c Δ t + {I}_{n} + {T}_{n}\end{matrix} ] \qquad ( 3 )$$

where \tilde{Z}=[p₁, p₂ . . . , pₙ]^{T} and y=(xᵣ, yᵣ, zᵣ, Δt), which are the measurements and state, respectively. The first-order approximation of the function can be written as:

h(y+Δy)≈h(y)+HΔy (4)

where H is the Jacobian matrix:

$$H = [ \begin{matrix}- \frac{{x}^{( 1 )} - {x}_{1}}{{r}_{1}} & - \frac{{y}^{( 1 )} - {y}_{1}}{{r}_{1}} & - \frac{{z}^{( 1 )} - {z}_{1}}{{r}_{1}} & c \\ - \frac{{x}^{( 2 )} - {x}_{1}}{{r}_{2}} & - \frac{{y}^{( 2 )} - {y}_{1}}{{r}_{2}} & - \frac{{z}^{( 2 )} - {z}_{1}}{{r}_{2}} & c \\ … & … & … & … \\ - \frac{{x}^{( n )} - {x}_{1}}{{r}_{n}} & - \frac{{y}^{( n )} - {y}_{1}}{{r}_{n}} & - \frac{{z}^{( n )} - {z}_{1}}{{r}_{n}} & c\end{matrix} ] \qquad ( 5 )$$

The Gaussian-Newton-based non-linear WLS is employed to solve the unknown state y by iteration as follows:

Δy=(H^{T}WH)⁻¹H^{T}W(\tilde{Z}−h(yᵢ)) (6)

yᵢ₊₁=yᵢ+Δy (7)

where W represents the weight matrix, which is a diagonal matrix determined by the variance of the pseudorange measurement error, and y₀ denotes the initial guess of the state, typically set to (0,0,0,0). The iteration process is halted once ∥Δy∥ falls below a predefined threshold, at which point the final y represents the determined position.

Note that the WLS positioning process requires two inputs, W and \tilde{Z}. We simplify the expression using the following equation:

y=f_{WLS}(W,\tilde{Z}) (8)

Although the description above represents an ideal scenario, various factors such as NLOS and multipath effects, imprecise ephemerides, or receiver errors can introduce biases. Consequently, the model can be reformulated as follows:

p=r+cΔt+l+T+b+E (9)

where b is the unmodeled bias. To achieve more accurate positioning results despite these biases, two strategies are employed. The first strategy involves directly correcting the pseudorange measurements, while the second strategy entails down-weighting the unhealthy measurements. In the following subsection, we will introduce a tightly coupled deep learning and GNSS framework designed for bias correction and weight prediction.

### B.2. Tightly Coupled Deep Learning/GNSS Framework

As illustrated in Equation (8), achieving optimal positioning results relies on accurately predicting the weights W or obtaining improved measurements \tilde{Z}. By utilizing the ground truth position and employing the MSE as the loss function, we can optimize both the measurements and weights using the following equations:

$$L ( {y}_{gt} , y ) = \frac{1}{2} {( {y}_{gt} - y )}^{2} \qquad ( 10 )$$

$$\frac{\partial L}{\partial \tilde{Z}} = \frac{\partial L}{\partial y} \frac{\partial y}{\partial \tilde{Z}} \qquad ( 11 )$$

$$\frac{\partial L}{\partial W} = \frac{\partial L}{\partial y} \frac{\partial y}{\partial W} \qquad ( 12 )$$

Equation (10) defines the loss function. Equations (11) and (12) demonstrate the gradients of \tilde{Z} and W, respectively, calculated using the chain rule under the specified conditions of the loss function. Should W and \tilde{Z} be derived from a neural network, these gradients are then propagated backward through the backpropagation process.

In this demonstration, three key features are selected as inputs:
Carrier-to-noise density (C/N₀):C/N₀ is an essential parameter that quantifies the quality of the received signal. It is defined as the ratio of the carrier power to the noise power per unit bandwidth and is typically expressed in decibels-hertz (dB-Hz).
Elevation Angle: The elevation angle is the vertical angle measured from the receiver's horizon to the line of sight of a satellite. This measurement indicates the satellite's position relative to the receiver's location on Earth. In urban environments, satellites with higher elevation angles are often LOS satellites and are less likely to be obstructed.
Residuals from Ordinary Least Squares Solution: Initially, the position is calculated using an OLS solution. The residuals from each measurement are then analyzed. This feature aids in identifying potentially problematic or unhealthy measurements, thereby enhancing the reliability of the positioning data.

These three features are compiled into a vector x=[C/N₀, Elevation, Residual] for the network input.

### B.2.1. Pseudorange Bias Correction Network

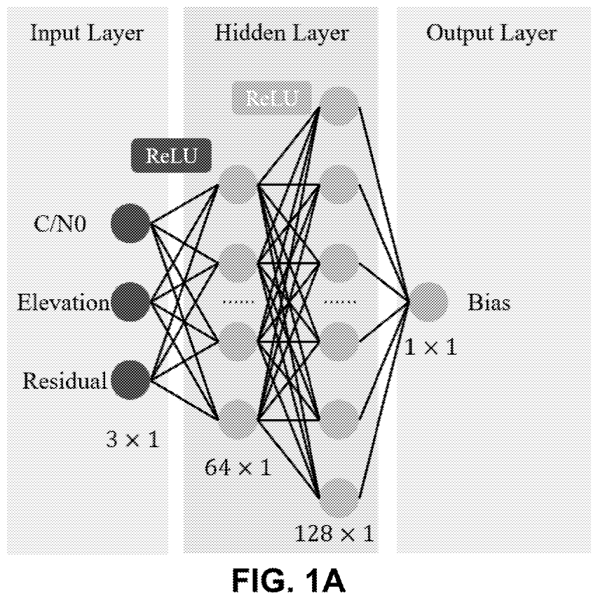

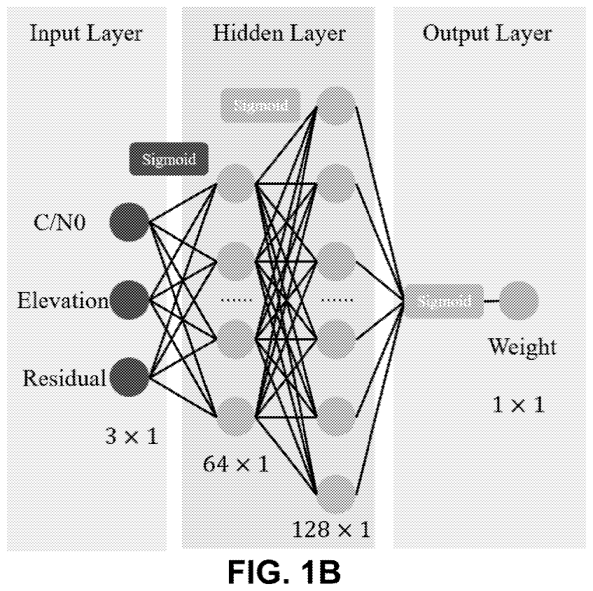

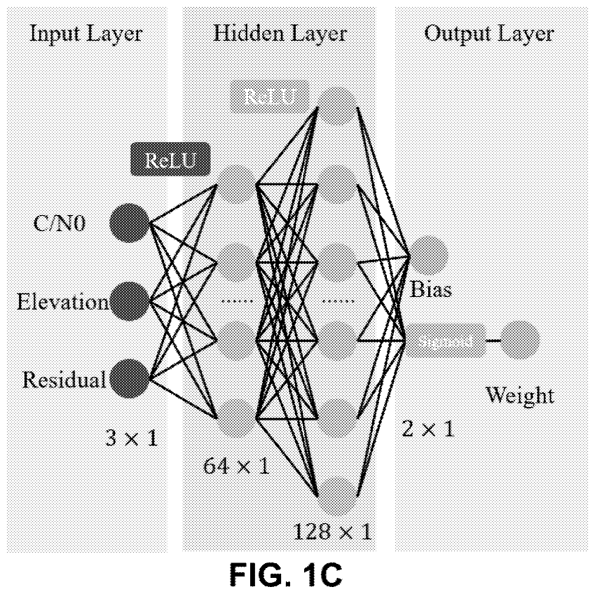

FIG. 1A depicts a detailed structure of the bias network. This network comprises a straightforward four-layer architecture, including the following layers.
An input layer, which has a configuration of 3×1, corresponding to the three input features.
Two hidden layers, sized 64×1 and 128×1 respectively, designed to progressively refine the feature representations.
An output layer, configured as 1×1, which outputs the predicted bias.

The ReLU is employed as the activation function throughout the network to introduce non-linearity, enhancing the model's capability to learn complex patterns. The final output represents the desired bias, which is used to predict the pseudorange bias as follows:

b=f_{nn,b}(X;Θ) (13)

where: X represents the batch input, defined as X=[x₁, x₂, . . . , xₙ] and b=[b₁, b₂, . . . , bₙ] denotes the corresponding batch output; and Θ symbolizes the set of parameters within the neural network. Using these definitions, the corrected measurements and resultant positions can be expressed as follows:

\tilde{\hat{Z}}=\tilde{Z}−b (14)

ŷ=f_{WLS}(W,\tilde{Z})=f_{WLS}(W,\tilde{Z}−f_{nn,b}(X;Θ) (15)

The training process can be formulated as follows:

$$Θ = arg {min}_{Θ} {\sum }_{i = 1}^{n} L ( {y}_{gt} , {f}_{WLS} ( W , \tilde{Z} - {f}_{nn , b} ( X ; Θ ) ) ) \qquad ( 16 )$$

$$\frac{\partial L}{\partial Θ} = \frac{\partial L}{\partial \hat{y}} \frac{\partial \hat{y}}{\partial \hat{W}} \frac{\hat{W}}{\partial Θ} \qquad ( 17 )$$

$${Θ}_{n + 1} = {Θ}_{n} - η \frac{\partial L}{\partial Θ} \qquad ( 18 )$$

Equation (16) illustrates that the training objective is to identify the optimal network parameters, Θ, that minimize the loss function. Equation (17) details the gradient transfer process, with n representing the learning rate.

### B.2.2. Weights Prediction Network

FIG. 1B depicts a detailed structure of the weight network. While the weight network is similar to the bias network, the weight network employs a sigmoid activation function instead of ReLU. The weight network is designed to predict the weights as follows:

ŵ=f_{nn,w}(X;Θ) (19)

Ŵ=diag(ŵ) (20)

where: ŵ=[w₁, w₂, . . . , wₙ] represents the vector of predicted weights in the batch output; and Ŵ is a diagonal matrix composed of the elements from ŵ. The positioning process is then formulated as follows:

ŷ=f_{WLS}(Ŵ,\tilde{Z})=f_{WLS}(f_{nn,w}(X;Θ),\tilde{Z}) (21)

The training process is formulated as follows:

$$Θ = {argmin}_{Θ} {{\sum }^{n}}_{i = 1} l ( {y}_{gt} , {f}_{WLS} ( {F}_{nn , w} ( {X}_{i} ; Θ ) , \tilde{Z} ) ) \qquad ( 22 )$$

$$\frac{\partial L}{\partial Θ} = \frac{\partial L}{\partial \hat{y}} \frac{\partial \hat{y}}{\partial \hat{W}} \frac{\partial \hat{W}}{\partial Θ} \qquad ( 23 )$$

$${Θ}_{n + 1} = {Θ}_{n} - n \frac{\partial L}{\partial Θ} \qquad ( 24 )$$

Equation (23) demonstrates the gradient transfer process within the tightly coupled deep learning and GNSS framework, tracing the path from the position loss function to the network parameters through the weights.

### B.2.3. Bias Correction and Weights Prediction Network

The previously described frameworks focus exclusively on either bias or weight prediction, yet it is possible to predict both simultaneously. FIG. 1C depicts an architecture of this dual-prediction network. In the bias correction and weights prediction network, ReLU serves as the activation function for the initial two layers. The output layer features two outputs: one for bias and another for weight. To ensure that the weight values range from zero to one, a sigmoid function is applied specifically to the weight output. This design allows the bias and weight predictions to share network parameters, effectively extracting information from the input. The predicted bias and weight are denoted as follows:

(b,Ŵ)=f_{nn,bw}(X;Θ) (25)

$$b = {f}_{nn , bw}^{b} ( X ; Θ ) \qquad ( 26 )$$

$$\hat{W} = {f}_{nn , bw}^{w} ( X ; Θ ) \qquad ( 27 )$$

The superscripts “b” and “w” represent the bias output and the weight output, respectively. With these outputs defined, the positioning process can be formulated as follows:

$$\hat{y} = {f}_{WLS} ( \hat{W} , \tilde{Z} - b ) = {f}_{WLS} ( {f}_{nn , bw}^{w} ( X ; Θ ) , \tilde{Z} - {f}_{nn , bw}^{b} ( X ; Θ ) ) \qquad ( 28 )$$

The training process is delineated as follows:

$$Θ = arg {min}_{Θ} {\sum }_{i = 1}^{n} L ( {y}_{gt} , {f}_{W L S} ( \hat{W} , \tilde{Z} - b ) ) \qquad ( 29 )$$

$$\frac{\partial L}{\partial Θ} = \frac{\partial L}{\partial b} \frac{\partial b}{\partial Θ} + \frac{\partial L}{\partial W} \frac{\partial W}{\partial Θ} \qquad ( 30 )$$

$${Θ}_{n + 1} = {Θ}_{n} - η \frac{\partial L}{\partial Θ} \qquad ( 31 )$$

Equation (30) encapsulates how the gradients are derived from both the biases and weights, effectively linking the loss function to the network parameters Θ through tightly integrated feedback loops.

### C. Experiment

In the preceding section, we detailed the training and prediction processes for our tightly coupled deep learning GNSS positioning framework. In this section, we will evaluate our approach and compare its performance against other tools. To facilitate a concise discussion, hereinafter we will use the abbreviations TDL-B network, TDL-W network, and TDL-BW network to refer to the pseudorange bias correction network, the weights prediction network, and the bias correction and weights prediction network, respectively.

### C.1. Framework Overview

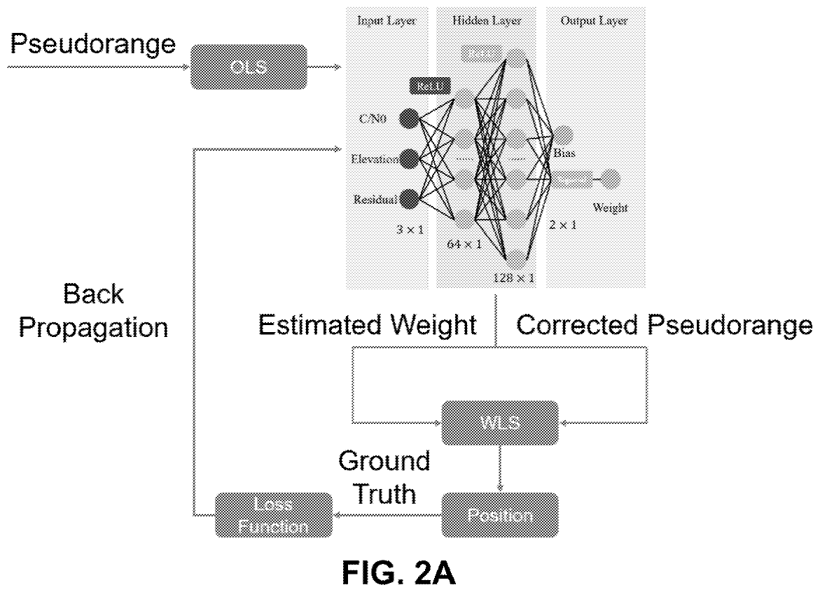

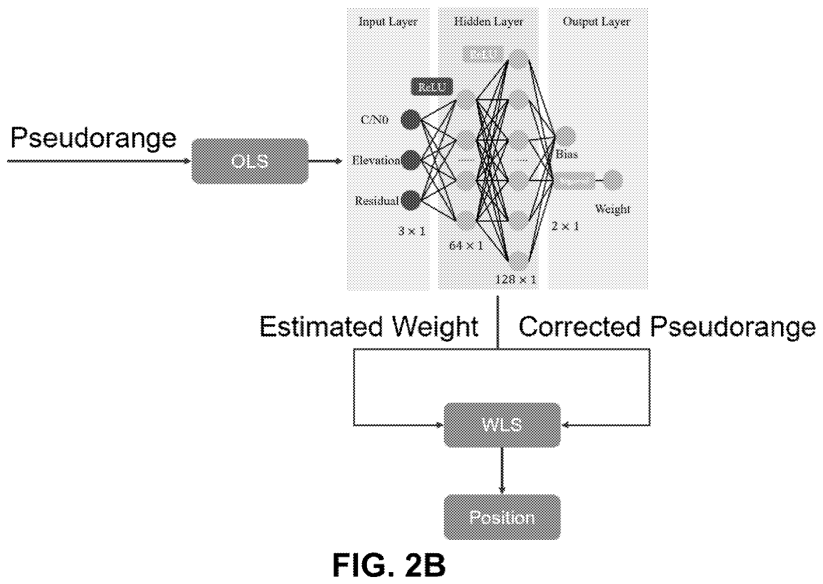

FIGS. 2A and 2B illustrate the training and prediction processes, respectively. In the training process, pseudoranges are processed using an OLS method to provide an initial solution. Subsequently, extracted features, including C/N₀, elevation angle, and least squares residuals, are fed into the network. The network then predicts the pseudorange errors that need correction and estimates weights for each satellite. A WLS calculation is performed to determine the position. The loss function calculates the error between the ground truth and the estimated position, and backpropagation is used to optimize the network. The prediction process mirrors the training process but concludes at the WLS step, outputting the final position.

### C.2. Experiment Setup

TABLE 2
Details of the datasets.

| Dataset | Date | DoU | Epoch | Samples | Usage |
|---|---|---|---|---|---|
| KLT1 | 2021 Jun. 10 | Light | 203 | 4676 | testing |
| KLT2 | 2021 Jun. 10 | Light | 209 | 4914 | testing |
| KLT3 | 2021 Jun. 10 | Light | 404 | 8857 | training |
| Whampoa | 2021 Jul. 14 | Deep | 1205 | 12926 | testing |

TABLE 3
Details of the sensors.

| Sensor | Output | Frequency(Hz) | Other |
|---|---|---|---|
| SPAN-CPT | coordinate | 100 | / |
| Ublox F9P | Pseudorange | 1 | GPS L1, BeiDou B1, |
| | | | Galileo E1, GLONASS G1 |

Four datasets are utilized for evaluation. Three of these datasets were collected in the urban areas of Hong Kong's Kowloon Tong (KLT), and one dataset was gathered in the Whampoa area of Hong Kong. KLT is characterized as a light urban area, whereas Whampoa is considered a deep urban area with an approximate 2D positioning error of 18 meters. The specific details of each dataset are provided in Table 2, where DoU represents the degree of urbanization. KLT3 was designated for training, while the remaining datasets were used for testing.

A Ublox-F9P receiver was utilized to receive and decode GNSS signals at a frequency of 1 Hz. Additionally, a NovAtel SPAN-CPT system, providing a RTK GNSS/INS integrated solution, was used to generate centimeter-level ground truth data at 100 Hz. Further details are provided in Table 3. These setups are consistent with those used in our previously open-sourced UrbanNav datasets.

TABLE 4
Training details.

| Component | Specification |
|---|---|
| System | Ubuntu 20.04 |
| CPU | AMD 5900x |
| Graphics Card | Nvidia 4090 |
| Memory | 128 Gigabytes |
| Loss Function | Mean Square Error (MSE) |
| Epoch | 500 for TDL-B and TDL-W, 100 for TDL-BW |
| Optimizer | Adam |
| Learning Rate | 0.001 |

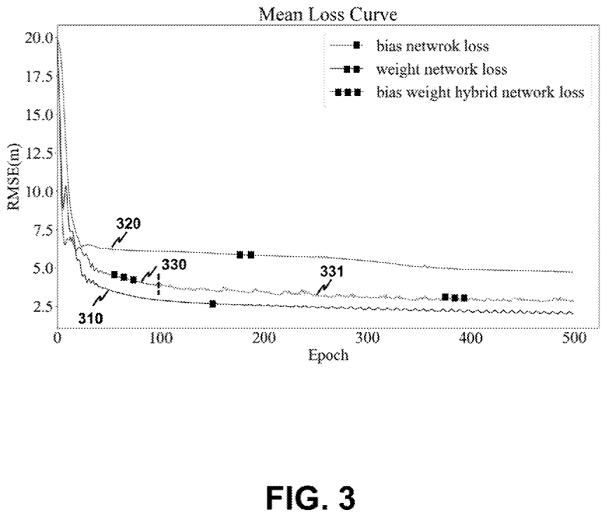

Details of the training process for the three networks are outlined in Table 4. While most parameters are consistent across the networks, the number of training epochs varies. Specifically, the TDL-BW model utilizes fewer epochs to prevent overfitting, which is a risk due to its complex nature. The training loss curves for the bias and weight networks are illustrated in FIG. 3. In FIG. 3, a first curve 310 represents the mean position loss of the bias network. A second curve 320 is associated with the weight network. A third curve segment 330 depicts the loss curve for the bias-weight hybrid network, terminating at the 100th epoch. The continuous curve segment 331 highlights a potential risk of overfitting within the bias-weight hybrid network.

The training process involves a critical detail regarding the initial state y₀, which should not be set as (0,0,0,0). As depicted in Equations (16), (22), and (29), the process consists of a two-step optimization. Initially, the position state is solved using WLS optimization, and this solution is then tightly coupled to the network. The gradient of the weight in Equation (6) largely depends on the H matrix, which is derived from the current position solution. Per Equations (6) and (7), the solution accumulates iteratively. In early iterations, significant changes in the solution result in drastic alterations to the H matrix, leading to unstable weight gradients. This instability can cause the optimization to fall into local minima and fail to converge. To mitigate this issue, the initial state is derived from the solution of an OLS calculation, which is nearly converged. Consequently, the H matrix remains relatively stable, enhancing the reliability of the training process.

### C.3. Experiment Results

### C.3.1. Competing Methods

In this section, we present our results and compare them with those obtained using RTKLIB and goGPS. Specifically, in RTKLIB, the weights assigned to each measurement are primarily derived from the elevation angles:

$${σ}^{2} ( θ ) = {a}^{2} + \frac{{b}^{2}}{s i {n}^{2} θ} \qquad ( 32 )$$

$$w = \frac{1}{{σ}^{2} ( θ )} \qquad ( 33 )$$

In RTKLIB, the weight assigned to each measurement depends on the elevation angle, denoted by θ. The coefficients a and b, known as super parameters, are typically set at 0.3. Meanwhile, in goGPS, weights are computed based on both the C/N0 and the elevation angle, as follows:

$${k}_{1} ( s ) = - \frac{s - {s}_{1}}{a} , {k}_{2} ( s ) = \frac{s - {s}_{1}}{{s}_{0} - {s}_{1}} , \qquad ( 34 )$$

$$w = \{ \begin{matrix}\frac{1}{{sin}^{2} θ} ( {10}^{{k}_{1} ( s )} ( ( \frac{A}{{10}^{{k}_{1} ( {s}_{0} )}} - 1 ) {k}_{2} ( S ) + 1 ) ) , & S < {s}_{1} , \\ 1 , & \frac{C}{{N}_{0}} \geq {s}_{1} .\end{matrix}$$

In this formula, S represents the C/N₀, and θ denotes the elevation angle. The parameters A, a, s₀, and s₁ are super parameters and are typically set to 30, 20, 10, and 50, respectively. These values are crucial for determining the weights based on the quality and position of the satellite signals.

### C.3.2. Results and Analysis

TABLE 5
2D mean error on testing datasets.

| Dataset | TDL-BW(m) | TDL-B(m) | TDL-W(m) | goGPS(m) | RTKLIB(m) |
|---|---|---|---|---|---|
| KLT1 | 1.84 | 2.24 | 2.57 | 1.88 | 2.44 |
| KLT2 | 1.86 | 2.35 | 2.89 | 2.66 | 4.48 |
| Whampoa | 10.94 | 17.81 | 16.11 | 13.95 | 20.89 |

TABLE 6
3D mean error on testing datasets.

| Dataset | TDL-BW(m) | TDL-B(m) | TDL-W(m) | goGPS(m) | RTKLIB(m) |
|---|---|---|---|---|---|
| KLT1 | 4.72 | 5.30 | 9.92 | 18.14 | 10.31 |
| KLT2 | 3.92 | 5.89 | 7.75 | 15.44 | 10.94 |
| Whampoa | 28.31 | 49.45 | 42.49 | 50.55 | 60.62 |

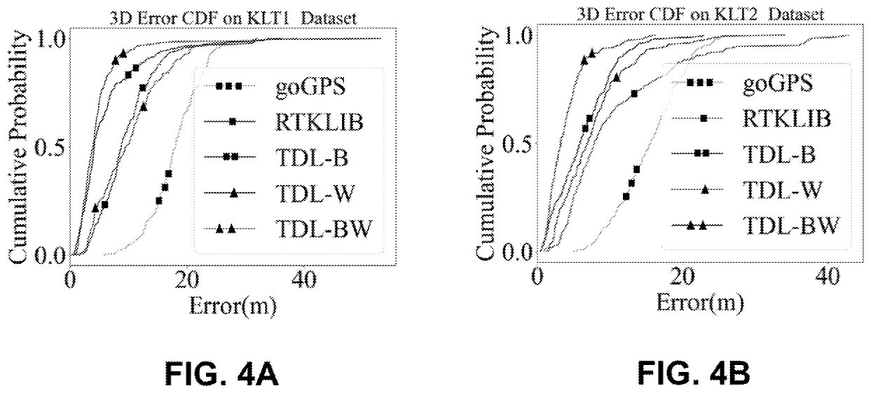

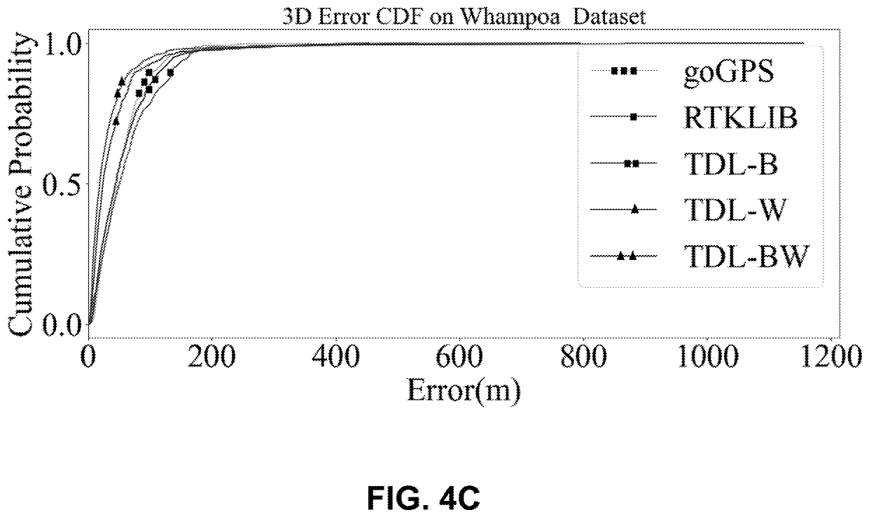

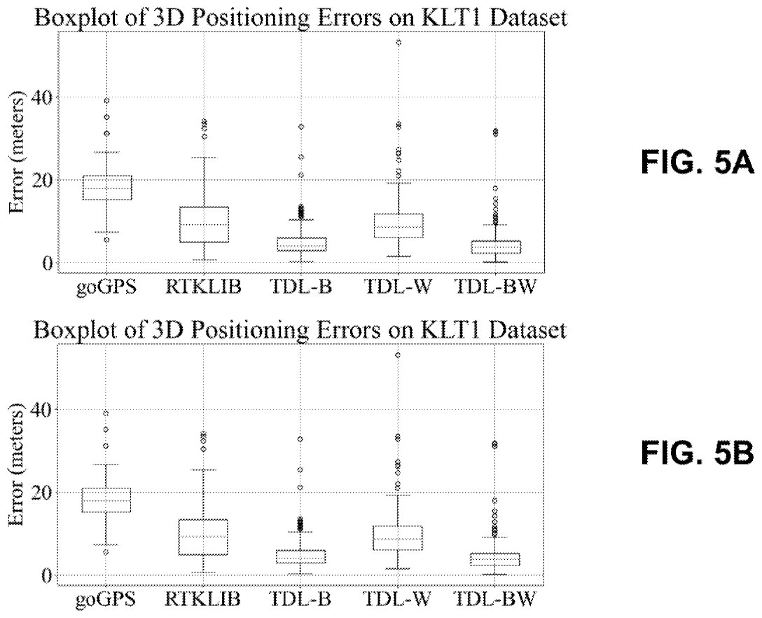

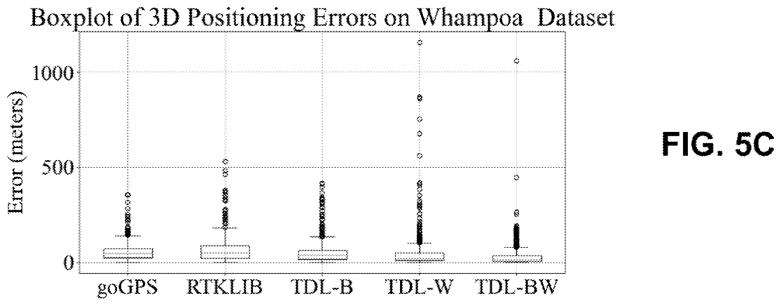

The 2D and 3D positioning MSE errors are presented in Table 5 and Table 6, respectively. Additionally, a CDF plot of the 3D errors, a boxplot of the 3D errors, and a detailed view of these errors are depicted in FIGS. 4A-4C and FIGS. 5A-5C. FIGS. 4A-4C plot CDF curves for 3D error of the compared methods on the three datasets, where KLT1 Dataset, KLT2 Dataset and Whampoa Dataset are used for FIGS. 4A, 4B and 4C, respectively. FIGS. 5A-5C plot boxplot graphs for 3D error of the compared methods on the three datasets, where KLT1 Dataset, KLT2 Dataset and Whampoa Dataset are used for FIGS. 5A, 5B and 5C, respectively. In the 2D error comparison, the TDL-B and TDL-W models perform worse than goGPS; however, their 3D error results are significantly better than those of both goGPS and RTKLIB. This discrepancy arises because the training process primarily utilizes the 3D error to calculate the loss function, leading to a focused analysis on 3D errors.

According to Table 6, CDF graphs shown in FIG. 4 and boxplots shown in FIG. 5, it is evident that the TDL-BW consistently outperforms others in terms of both accuracy and reliability. Among the three CDF graphs, TDL-BW demonstrates significant advantages, primarily characterized by its rapid convergence to a cumulative probability of 1, indicating superior performance in error minimization compared to other methods. The red curve of TDL-BW swiftly approaches a cumulative probability near 1, suggesting that the majority of measurement errors are confined within this lower error threshold. This performance not only shows a smooth and consistent upward trend without abrupt jumps or fluctuations but also underscores its stability across various measurement conditions. Specifically in boxplot, TDL-BW exhibits the lowest mean errors and standard deviations, indicating a high level of precision and stability, which is crucial for applications requiring rigorous spatial accuracy.

### D. Discussion

TABLE 7
The predicted weight and bias in Case A.

| Loca- | | | | Loca- | | | |
|---|---|---|---|---|---|---|---|
| tion | Condition | weight | bias | tion | Condition | weight | Bias |
| G07 | LOS | 0.62 | 4.61 | G03 | NLOS | 0.00 | 5.44 |
| G01 | LOS | 0.36 | 3.12 | G14 | NLOS | 0.00 | 3.22 |
| G30 | NLOS | 0.14 | 3.48 | G17 | NLOS | 0.00 | 7.81 |
| C11 | LOS | 0.12 | 2.27 | G22 | LOS | 0.00 | 5.77 |
| G21 | LOS | 0.01 | 5.88 | C13 | NLOS | 0.00 | 6.00 |
| C07 | NLOS | 0.00 | 4.72 | C08 | NLOS | 0.00 | 2.25 |
| C23 | NLOS | 0.00 | 6.83 | C25 | NLOS | 0.00 | 2.19 |
| G28 | NLOS | 0.00 | 4.41 | | | | |

TABLE 8
The predicted weight and bias in Case B.

| Loca- | | | | Loca- | | | |
|---|---|---|---|---|---|---|---|
| tion | Condition | weight | bias | tion | Condition | Weight | Bias |
| C10 | LOS | 1.00 | 0.40 | G12 | NLOS | 0.00 | 9.38 |
| G19 | LOS | 0.96 | 1.90 | G14 | NLOS | 0.00 | 8.32 |
| G06 | NLOS | 0.89 | 3.46 | G20 | NLOS | 0.00 | 13.99 |
| G17 | NLOS | 0.65 | 1.86 | C08 | NLOS | 0.00 | 2.32 |
| C07 | LOS | 0.21 | 0.22 | C13 | NLOS | 0.00 | 6.19 |
| G02 | NLOS | 0.00 | 14.72 | C28 | NLOS | 0.00 | 20.50 |
| G05 | NLOS | 0.00 | 11.85 | C30 | NLOS | 0.00 | 7.43 |

In the section, we focus on two typical outliers of TDL-BW in the two representative scenarios, Case A and Case B. The errors in the two cases are 31.89 meters and 1061.09 meters, respectively. These scenarios highlight the challenges posed by LOS and NLOS conditions on satellite signal reception and the consequent effects on positioning accuracy.

Table 7 lists the weights and biases predicted for various locations in the scenario of Case A. Each location is under either a LOS condition or a NLOS condition on satellite signal reception. As shown in the results of Table 7, the TDL-BW network outputs show a clear differentiation between LOS and NLOS signals. This scenario, characterized by a tree canopy, predominantly exhibits NLOS conditions, impacting the weight distribution among satellites. Notably, satellites labeled as LOS (G07 and G01) receive non-zero weights, affirming the network's capability to identify viable signals amidst obstructions. However, the network misclassifies satellite G22, positioned near the edge of a building possibly affected by diffraction, assigning it no weight. A critical observation here is the excessive elimination of NLOS satellites, which, while reducing noise from obstructed signals, also minimizes redundancy in the available data for accurate positioning, potentially compromising the robustness of the positioning solution.

Table 8 presents the weights and biases predicted for locations in the scenario of Case B. Each location is under either a LOS condition or a NLOS condition on satellite signal reception. From the results shown in Table 8 for case B, this scenario demonstrates a similar pattern where the network effectively identifies and assigns higher weights to LOS satellites (C10 and G19). It also appropriately categorizes C07, which, despite potential obstructions, is deemed reliable. However, akin to Case A, the network's stringent filtering leads to the exclusion of numerous NLOS satellites, manifesting in an overly sparse dataset that might detract from the accuracy of the resultant positioning due to insufficient satellite coverage and geometry.

Both cases underscore the TDL-BW network's proficiency in distinguishing between LOS and NLOS satellites and its consequential decision-making concerning weight assignments. While this ability is advantageous for enhancing signal quality by excluding NLOS influences, it also raises concerns regarding the adequacy of satellite data for reliable positioning. The elimination of too many satellites, particularly under dense canopy or urban settings where NLOS conditions are prevalent, could severely limit the system's operational effectiveness by reducing the geometric diversity necessary for optimal positioning. The less robust performance of TDL-W in several situations is also due to the failure to allocate weights to enough measurements. In contrast, the results from TDL-B in the two cases are 5.52 meters and 223.50 meters, which are much better than TDL-BW and TDL-W. Therefore, due to the unreliable results from TDL-W and TDL-BW, where only a few measurements are weighted, it is advisable to switch to TDL-B.

### D. Embodiments of the Present Disclosure

Embodiments of the present disclosure are elaborated as follows based on the details, examples, applications, etc. of the framework as disclosed above, including TDL-B, TDL-W, and TDL-BW.

The present disclosure provides a method for determining a location of a receiver on Earth in a GNSS. The method is a generalized one in that each one of TDL-BW, TDL-B and TDL-W networks can be adapted to be used in the method.

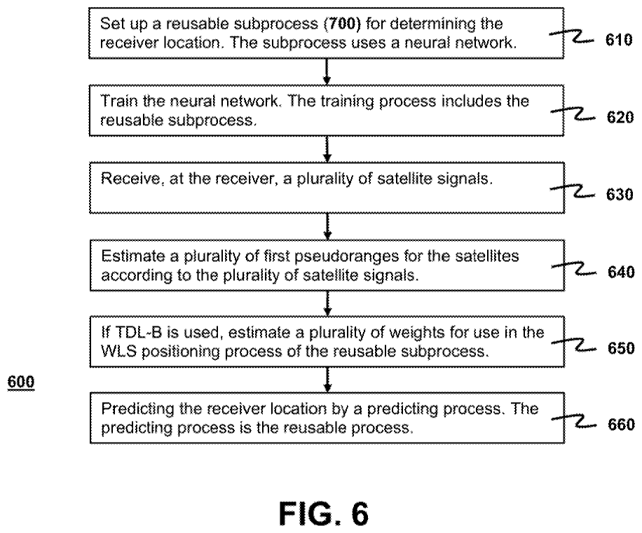

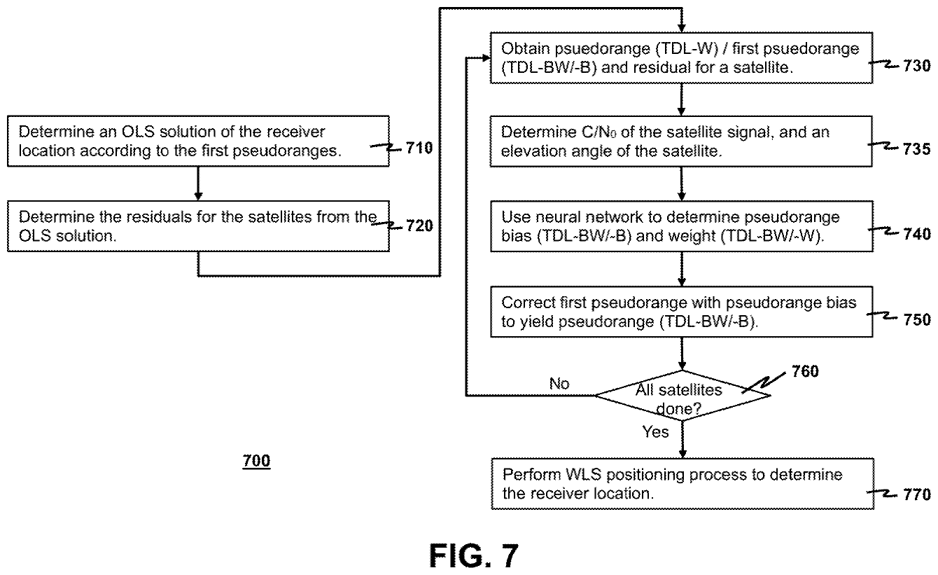

Exemplarily, the method is illustrated with the aid of FIGS. 6 and 7. FIG. 6 depicts a first flowchart showing exemplary steps of the disclosed method (referenced as 600). A reusable subprocess 700 is reused for neural-network training and receiver-location prediction in the method 600. FIG. 7 depicts a second flowchart showing exemplary steps of the reusable subprocess 700.

In the method 600, the receiver on Earth is used to receive a plurality of satellite signals transmitted from a plurality satellites of the GNSS. A processor, which is a computing processor or an equivalent thereof, is used to process the plurality of satellite signals to determine the location of the receiver. In the method 600, a neural network is used in the reusable subprocess 700, where the neural network is selected from the TDL-BW, TDL-B and TDL-W networks. Refer to FIG. 6. The method 600 comprises steps 610, 620, 630, 640, 650 and 660.

In the step 610, the processor sets up the reusable subprocess 700. The reusable subprocess 700 is used for determining the location of the receiver through estimating a plurality of pseudoranges (if the TDL-BW network or the TDL-B network is selected to be the neural network) and a plurality of weights (if the TDL-BW network or the TDL-W network is selected to be the neural network) for the plurality of satellites. Details of the reusable subprocess 700 will be explored later.

Several technical terms are defined first. An individual satellite in the plurality of satellites is arranged to transmit a corresponding satellite signal in the plurality of satellite signals. The corresponding satellite signal is received at the receiver. The individual satellite is associated with a corresponding pseudorange in the plurality of pseudoranges. It means that the corresponding satellite signal is used in measuring the corresponding pseudorange between the individual satellite and the receiver. The individual satellite is also associated with a corresponding weight in the plurality of weights. The corresponding weight is inversely varying with respect to a measurement error in measuring the corresponding pseudorange.

In the step 630, the receiver receives the plurality of satellite signals from the plurality of satellites.

In the step 640, the processor estimates a plurality of first pseudoranges for the plurality of satellites according to the plurality of satellite signals. The individual satellite is associated with a corresponding first pseudorange in the plurality of pseudoranges. The corresponding first pseudorange is a pseudorange measured from the individual satellite to the receiver based on the corresponding satellite signal received at the receiver. The corresponding first pseudorange is regarded as an initial estimate of the corresponding pseudorange of the individual satellite.

If the TDL-B network is used as the neural network in the reusable subprocess 700, the step 650 is performed. In case the TDL-W or TDL-BW network is used, it is not necessary to perform the step 650. In the step 650, the processor estimates the plurality of weights for the plurality of satellites. The plurality of weights is used in a WLS positioning process for determining the location of the receiver.

After the steps 610, 630, 640 and 650 (if required) are performed, the processor predicts, in the step 660, the location of the receiver by a predicting process. Particularly, the predicting process is the reusable subprocess 700. That is, the predicting process is implemented with the reusable subprocess 700.

Before the location of the receiver is predicted in the step 660, it is required to ensure that the neural network employed in the reusable subprocess 700 has been trained. In the step 620, the processor trains the neural network with a training process according to a training dataset containing ground-truth positions. Furthermore, the training process includes the reusable subprocess 700 (meaning that the reusable subprocess 700 is incorporated into the training process), and the reusable subprocess 700 forms a core part of the training process. The step 620 is performed before performing the step 660. In FIG. 6, as an example for illustration, the step 620 is performed before receiving the plurality of satellite signals in the step 630. Nonetheless, the present disclosure is not limited only to training the neural network before the plurality of satellite signals is received; the step 620 may be performed anytime as deemed appropriate by those skilled in the art before executing the predicting process of predicting the location of the receiver.

Details of the reusable subprocess 700 are elaborated as follows. Refer to FIG. 7. The reusable subprocess 700 includes steps 710, 720, 730, 735, 740, 750, 760 and 770.

In the step 710, an OLS solution of the location of the receiver is determined according to the plurality of first pseudoranges. If the neural network is the TDL-W network, the plurality of first pseudoranges is the plurality of pseudoranges since the reusable subprocess 700 does not refine the plurality of pseudoranges. If the neural network is the TDL-BW or TDL-B network, the plurality of first pseudoranges is further refined or corrected in the reusable subprocess 700 to yield the plurality of pseudoranges.

In the step 720, a plurality of residuals for the plurality of satellites is determined from the OLS solution obtained in the step 710.

In the step 730, a corresponding residual associated with the individual satellite from the plurality of residuals is extracted. If the neural network is the TDL-BW or TDL-B network, the step 730 further extracts the corresponding first pseudorange from the plurality of first pseudoranges. If the neural network is the TDL-W network, the step 730 further extracts the corresponding pseudorange from the plurality of pseudoranges.

In the step 735, the reusable subprocess 700 determines a carrier-to-noise density, i.e. C/N₀, of the corresponding satellite signal received at the receiver, and an elevation angle of the corresponding satellite with respect to the receiver.

The context of the step 740 depends on the choice of the neural network.

If the TDL-BW network (namely, a bias correction and weights prediction network) is selected as the neural network, in the step 740, the reusable subprocess 700 uses the TDL-BW network to simultaneously determine a corresponding pseudorange bias and the corresponding weight according to the C/N₀, the elevation angle and the corresponding residual, where the corresponding pseudorange bias is associated with the individual satellite.

If the TDL-B network (namely, a pseudorange bias correction network) is selected as the neural network, in the step 740, the reusable subprocess 700 uses the TDL-B network to determine a corresponding pseudorange bias according to the C/N₀, the elevation, and the corresponding residual. Similarly, the corresponding pseudorange bias is associated with the individual satellite.

If the TDL-W network (namely, a weights prediction network) is selected as the neural network, in the step 740, the reusable subprocess 700 uses the TDL-W network to determine the corresponding weight according to the C/N₀, the elevation angle, and the corresponding residual.

After the step 740 is performed, the step 750 is performed if the neural network is selected to be the TDL-BW or TDL-B network, and is not performed if the TDL-W is selected to be the neural network. In the step 750, the reusable subprocess 700 subtracts the corresponding pseudorange bias from the corresponding first pseudorange to yield a corrected pseudorange. Furthermore, the corrected pseudorange is set to be the corresponding pseudorange.

In the step 760, the reusable subprocess 700 repeats the steps 730, 735, 740 and 750 (if required) for respective satellites in the plurality of satellites until the plurality of pseudoranges (if the neural network is the TDL-BW or TDL-B network) and the plurality of weights (if the neural network is the TDL-BW or TDL-W network) are determined.

After the step 760 is completed, the reusable subprocess 700 performs the WLS positioning process to determine the location of the receiver according to the plurality of pseudoranges and the plurality of weights in the step 770.

Other implementation details of the disclosed method 600 are elaborated as follows.

The neural network comprises an input layer, a plurality of hidden layers, and an output layer. The input layer is used for receiving the C/N₀ of the corresponding satellite signal, the elevation angle of the corresponding satellite, and the corresponding residual associated with the individual satellite. The plurality of hidden layers is located between the input and output layers. The output layer is used for outputting the corresponding pseudorange bias (if the neural network is the TDL-BW or TDL-B network) and the corresponding weight (if the neural network is the TDL-BW or TDL-W network).

The neural network may be further configured as follows. The input layer is configured to receive a feature vector comprising the C/N₀, the elevation angle, and the corresponding residual. The plurality of hidden layers comprises at least two hidden layers arranged in series. A number of processing nodes in each successive hidden layer is greater than a number of processing nodes in a preceding hidden layer. The output layer is configured to output the corresponding pseudorange bias (if the neural network is the TDL-BW or TDL-B network) and the corresponding weight (if the neural network is the TDL-BW or TDL-W network).

If the TDL-BW network is selected to be the neural network, a ReLU is used as a first activation function throughout the input layer and the plurality of hidden layers, and a sigmoid function is used as a second activation function in generating the corresponding weight in the output layer.

If the TDL-B network is selected to be the neural network, the ReLU is used as an activation function throughout the input layer and the plurality of hidden layers.

If the TDL-W network is selected to be the neural network, the sigmoid function is used as an activation function throughout the input layer, the plurality of hidden layers and the output layer.

In certain embodiments, the plurality of hidden layers consists of first and second hidden layers connected in series. That is, the plurality of hidden layers has two hidden layers. The first hidden layer is connected to the input layer. The second hidden layer is connected to the output layer.

In certain embodiments, the neural network is configured as follows. The input layer has a size of 3×1. The first hidden layer has a size of 64×1. The second hidden layer has a size of 128×1. If the neural network is the TDL-BW network, the output layer has a size of 2×1. If the neural network is the TDL-B or TDL-W network, the output layer has a size of 1×1.

In certain embodiments, the training process is arranged to learn a set of parameters, Θ, within the network by determining Θ according to Equations (29), (16) and (22) when the neural network is selected to be the TDL-BW network, the TDL-B network and the TDL-W network, respectively.

In certain embodiments, the training process further includes: calculating the loss function; calculating an adjustment to Θ according to the loss function; and backpropagating the adjustment to the network for optimizing the network.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for determining a location of a receiver on Earth in a global navigation satellite system (GNSS), the method comprising:
receiving, by the receiver, a plurality of satellite signals from a plurality of satellites of the GNSS, wherein an individual satellite in the plurality of satellites is arranged to transmit a corresponding satellite signal in the plurality of satellite signals to the receiver;
estimating, by a processor, a plurality of first pseudoranges for the plurality of satellites according to the plurality of satellite signals, the individual satellite being associated with a corresponding first pseudorange in the plurality of pseudoranges, the corresponding first pseudorange being measured from the individual satellite to the receiver;
setting up, by the processor, a reusable subprocess for determining the location of the receiver through estimating a plurality of pseudoranges and a plurality of weights for the plurality of satellites, the individual satellite being associated with a corresponding pseudorange in the plurality of pseudoranges and a corresponding weight in the plurality of weights, the corresponding pseudorange being obtained from the corresponding first pseudorange after correction is made, the corresponding weight being inversely varying with respect to an error in measuring the corresponding pseudorange, wherein the reusable subprocess comprises the steps of:
(a) determining an ordinary least squares (OLS) solution of the location of the receiver according to the plurality of first pseudoranges;
(b) determining a plurality of residuals for the plurality of satellites from the OLS solution of the location of the receiver;
(c) extracting the corresponding first pseudorange from the plurality of first pseudoranges, and a corresponding residual associated with the individual satellite from the plurality of residuals;
(d) determining a carrier-to-noise density (C/N₀) of the corresponding satellite signal received at the receiver, and an elevation angle of the corresponding satellite with respect to the receiver;
(e) using a bias correction and weights prediction network to simultaneously determine a corresponding pseudorange bias and the corresponding weight according to the C/N₀ of the corresponding satellite signal, the elevation angle of the corresponding satellite, and the corresponding residual associated with the individual satellite, wherein the corresponding pseudorange bias is associated with the individual satellite;
(f) subtracting the corresponding pseudorange bias from the corresponding first pseudorange to yield a corrected pseudorange, wherein the corrected pseudorange is set to be the corresponding pseudorange;
(i) repeating the steps (c)-(f) for respective satellites in the plurality of satellites until the plurality of pseudoranges and the plurality of weights are determined; and
(j) performing a weighted least squares (WLS) positioning process to determine the location of the receiver according to the plurality of pseudoranges and the plurality of weights;
predicting, by the processor, the location of the receiver by a predicting process, wherein the predicting process is the reusable process; and
before the location of the receiver is predicted, training, by the processor, the network with a training process according to a training dataset containing ground-truth positions, wherein the training process includes the reusable subprocess.

2. The method of claim 1, wherein the network comprises:
an input layer for receiving the C/N₀ of the corresponding satellite signal, the elevation angle of the corresponding satellite, and the corresponding residual associated with the individual satellite;
an output layer for outputting the corresponding pseudorange bias and the corresponding weight; and
a plurality of hidden layers between the input and output layers; and
wherein a rectified linear unit (ReLU) is used as a first activation function throughout the input layer and the plurality of hidden layers, and a sigmoid function is used as a second activation function in generating the corresponding weight in the output layer.

3. The method of claim 2, wherein the plurality of hidden layers consists of first and second hidden layers connected in series, the first hidden layer connecting to the input layer, the second hidden layer connecting to the output layer.

4. The method of claim 2, wherein:
the input layer is configured to receive a feature vector comprising the C/N₀, the elevation angle, and the corresponding residual;
the plurality of hidden layers comprises at least two hidden layers arranged in series, wherein a number of processing nodes in each successive hidden layer is greater than a number of processing nodes in a preceding hidden layer; and
the output layer is configured to output the corresponding pseudorange bias and the corresponding weight.

5. The method of claim 1, wherein the training process is arranged to learn a set of parameters, Θ, within the network by determining Θ according to
$$Θ = arg {min}_{Θ} {\sum }_{i = 1}^{n} L ( {y}_{gt} , {f}_{WLS} ( \hat{W} , \tilde{Z} - b ) )$$
where:
Ŵ is a diagonal matrix formed by the plurality of weights as estimated;
\tilde{Z} denotes the plurality of first pseudoranges;
b denotes a plurality of pseudorange biases formed by respective corresponding pseudorange biases for the respective satellites;
f_{WLS}(·) denotes the WLS positioning process;
L(·) denotes a loss function;
n, which is a dimension of \tilde{Z}, is a number of the respective satellites in the plurality of satellites; and
y_{gt} denotes a ground-truth position.

6. The method of claim 5, wherein the training process further includes:
calculating the loss function;
calculating an adjustment to Θ according to the loss function; and
backpropagating the adjustment to the network for optimizing the network.

7. A method for determining a location of a receiver on Earth in a global navigation satellite system (GNSS), the method comprising:
receiving, by the receiver, a plurality of satellite signals from a plurality of satellites of the GNSS, wherein an individual satellite in the plurality of satellites is arranged to transmit a corresponding satellite signal in the plurality of satellite signals to the receiver;
estimating, by a processor, a plurality of first pseudoranges for the plurality of satellites according to the plurality of satellite signals, the individual satellite being associated with a corresponding first pseudorange in the plurality of pseudoranges, the corresponding first pseudorange being measured from the individual satellite to the receiver;
estimating, by the processor, a plurality of weights for the plurality of satellites, the plurality of weights being used in a weighted least squares (WLS) positioning process for determining the location of the receiver;
setting up, by the processor, a reusable subprocess for determining the location of the receiver through estimating a plurality of pseudoranges for the plurality of satellites, the individual satellite being associated with a corresponding pseudorange in the plurality of pseudoranges and a corresponding weight in the plurality of weights, the corresponding pseudorange being obtained from the corresponding first pseudorange after correction is made, the corresponding weight being inversely varying with respect to an error in measuring the corresponding pseudorange, wherein the reusable subprocess comprises the steps of:
(a) determining an ordinary least squares (OLS) solution of the location of the receiver according to the plurality of first pseudoranges;
(b) determining a plurality of residuals for the plurality of satellites from the OLS solution of the location of the receiver;
(c) extracting the corresponding first pseudorange from the plurality of first pseudoranges, and a corresponding residual associated with the individual satellite from the plurality of residuals;
(d) determining a carrier-to-noise density (C/N₀) of the corresponding satellite signal received at the receiver, and an elevation angle of the corresponding satellite with respect to the receiver;
(e) using a pseudorange bias correction network to determine a corresponding pseudorange bias according to the C/N₀ of the corresponding satellite signal, the elevation angle of the corresponding satellite, and the corresponding residual associated with the individual satellite, wherein the corresponding pseudorange bias is associated with the individual satellite;
(f) subtracting the corresponding pseudorange bias from the corresponding first pseudorange to yield a corrected pseudorange, wherein the corrected pseudorange is set to be the corresponding pseudorange;
(i) repeating the steps (c)-(f) for respective satellites in the plurality of satellites until the plurality of pseudoranges is determined; and
(j) performing the WLS positioning process to determine the location of the receiver according to the plurality of pseudoranges and the plurality of weights;
predicting, by the processor, the location of the receiver by a predicting process, wherein the predicting process is the reusable process; and
before the location of the receiver is predicted, training, by the processor, the network with a training process according to a training dataset containing ground-truth positions, wherein the training process includes the reusable subprocess.

8. The method of claim 7, wherein the network comprises:
an input layer for receiving the C/N₀ of the corresponding satellite signal, the elevation angle of the corresponding satellite, and the corresponding residual associated with the individual satellite;
an output layer for outputting the corresponding pseudorange bias; and
a plurality of hidden layers between the input and output layers; and
wherein a rectified linear unit (ReLU) is used as an activation function throughout the input layer and the plurality of hidden layers.

9. The method of claim 8, wherein the plurality of hidden layers consists of first and second hidden layers connected in series, the first hidden layer connecting to the input layer, the second hidden layer connecting to the output layer.

10. The method of claim 8, wherein:
the input layer is configured to receive a feature vector comprising the C/N₀, the elevation angle, and the corresponding residual;
the plurality of hidden layers comprises at least two hidden layers arranged in series, wherein a number of processing nodes in each successive hidden layer is greater than a number of processing nodes in a preceding hidden layer; and
the output layer is configured to output the corresponding pseudorange bias.

11. The method of claim 10, wherein the training process is arranged to learn a set of parameters, Θ, within the network by determining Θ according to
$$Θ = arg {min}_{Θ} {\sum }_{i = 1}^{n} L ( {y}_{gt} , {f}_{WLS} ( W , \tilde{Z} - b ) )$$
where:
W is a diagonal matrix formed by the plurality of weights;
\tilde{Z} denotes the plurality of first pseudoranges;
b denotes a plurality of pseudorange biases formed by respective corresponding pseudorange biases for the respective satellites;
f_{WLS}(·) denotes the WLS positioning process;
L(·) denotes a loss function;
n, which is a dimension of \tilde{Z}, is a number of the respective satellites in the plurality of satellites; and
y_{gt} denotes a ground-truth position.

12. The method of claim 11, wherein the training process further includes:
calculating the loss function;
calculating an adjustment to Θ according to the loss function; and
backpropagating the adjustment to the network for optimizing the network.

13. A method for determining a location of a receiver on Earth in a global navigation satellite system (GNSS), the method comprising:
receiving, by the receiver, a plurality of satellite signals from a plurality of satellites of the GNSS, wherein an individual satellite in the plurality of satellites is arranged to transmit a corresponding satellite signal in the plurality of satellite signals to the receiver;
estimating, by a processor, a plurality of pseudoranges for the plurality of satellites according to the plurality of satellite signals, the individual satellite being associated with a corresponding pseudorange in the plurality of pseudoranges, the corresponding pseudorange being measured from the individual satellite to the receiver;
setting up, by the processor, a reusable subprocess for determining the location of the receiver through estimating a plurality of weights for the plurality of satellites, the individual satellite being associated with a corresponding weight in the plurality of weights, the corresponding weight being inversely varying with respect to an error in measuring the corresponding pseudorange, wherein the reusable subprocess comprises the steps of:
(a) determining an ordinary least squares (OLS) solution of the location of the receiver according to the plurality of pseudoranges;
(b) determining a plurality of residuals for the plurality of satellites from the OLS solution of the location of the receiver;
(c) extracting the corresponding pseudorange from the plurality of pseudoranges, and a corresponding residual associated with the individual satellite from the plurality of residuals;
(d) determining a carrier-to-noise density (C/N₀) of the corresponding satellite signal received at the receiver, and an elevation angle of the corresponding satellite with respect to the receiver;
(e) using a weights prediction network to determine the corresponding weight according to the C/N₀ of the corresponding satellite signal, the elevation angle of the corresponding satellite, and the corresponding residual associated with the individual satellite;
(f) repeating the steps (c)-(e) for respective satellites in the plurality of satellites until the plurality of weights is determined; and
(g) performing a weighted least squares (WLS) positioning process to determine the location of the receiver according to the plurality of pseudoranges and the plurality of weights;
predicting, by the processor, the location of the receiver by a predicting process, wherein the predicting process is the reusable process; and
before the location of the receiver is predicted, training, by the processor, the network with a training process according to a training dataset containing ground-truth positions, wherein the training process includes the reusable subprocess.

14. The method of claim 13, wherein the network comprises:
an input layer for receiving the C/N₀ of the corresponding satellite signal, the elevation angle of the corresponding satellite, and the corresponding residual associated with the individual satellite;
an output layer for outputting the corresponding weight; and
a plurality of hidden layers between the input and output layers; and
wherein a sigmoid function is used as an activation function throughout the input layer, the plurality of hidden layers and the output layer.

15. The method of claim 14, wherein the plurality of hidden layers consists of first and second hidden layers connected in series, the first hidden layer connecting to the input layer, the second hidden layer connecting to the output layer.

16. The method of claim 14, wherein:
the input layer is configured to receive a feature vector comprising the C/N₀, the elevation angle, and the corresponding residual;
the plurality of hidden layers comprises at least two hidden layers arranged in series, wherein a number of processing nodes in each successive hidden layer is greater than a number of processing nodes in a preceding hidden layer; and
the output layer is configured to output the corresponding weight.

17. The method of claim 13, wherein the training process is arranged to learn a set of parameters, Θ, within the network by determining Θ according to
$$Θ = arg {min}_{Θ} {\sum }_{i = 1}^{n} L ( {y}_{gt} , {f}_{WLS} ( \hat{W} , \tilde{Z} ) )$$
where:
Ŵ is a diagonal matrix formed by the plurality of weights as estimated;
\tilde{Z} denotes the plurality of pseudoranges;
b denotes a plurality of pseudorange biases formed by respective corresponding pseudorange biases for the respective satellites;
f_{WLS}(·) denotes the WLS positioning process;
L(·) denotes a loss function;
n, which is a dimension of \tilde{Z}, is a number of the respective satellites in the plurality of satellites; and
y_{gt} denotes a ground-truth position.

18. The method of claim 17, wherein the training process further includes:
calculating the loss function;
calculating an adjustment to Θ according to the loss function; and
backpropagating the adjustment to the network for optimizing the network.
